(19) United States
(12) Patent Application Publication
(10) Pub. No.: US 2009/0070744 A1
(43) Pub. Date: Mar. 12, 2009

(54) CRM SYSTEM AND METHOD HAVING DRILLDOWNS, ACLs, SHARED FOLDERS, A TRACKER AND A MODULE BUILDER

(75) Inventors: Jacob Andrew Taylor, Santa Clara, CA (US); Majed Itani, San Jose, CA (US); Ajay Gupta, Cupertino, CA (US); Andrew Wu, Sunnyvale, CA (US); Joseph Parsons, Austin, TX (US); Roger Smith, Morrisville, NC (US); Chris Nojima, San Francisco, CA (US)

Correspondence Address: DLA PIPER LLP (US ), 2000 UNIVERSITY AVENUE, EAST PALO ALTO, CA, 94303-2248, US

(73) Assignee: SugarCRM Inc., Cupertino, CA (US)

(21) Appl. No.: 12/200,301

(22) Filed: Aug. 28, 2008

Related U.S. Application Data
(60) Provisional application No. 60/968,484, filed on Aug. 28, 2007.
(60) Provisional application No. 60/977,527, filed on Oct. 4, 2007.

(51) Int. Cl. G06F 9/44

(52) U.S. Cl. 717/128

(57) ABSTRACT

A business application system, such as a CRM system, is provided wherein the system include deeper chart drill-downs, access control lists, shared folders, a tracker module and/or a modular builder.

### PRIORITY CLAIM(S)

This application claims the benefit under 35 USC 119(e) to U.S. Provisional Patent Application Ser. No. 60/968,484 filed on Aug. 28, 2007 and entitled “CRM System and Method Having Drilldowns, ACLs, Shared Folders, a Tracker and a Module Builder” (Attorney Docket No. 356649-991220) and U.S. Provisional Patent Application Ser. No. 60/977,527 filed on Oct. 4, 2007 and entitled “CRM System and Method Having Drilldowns, ACLs, Shared Folders, a Tracker and a Module Builder” (Attorney Docket No. 356649-991221), both of which are herein incorporated by reference in their entirely.

### FIELD

The invention relates generally to a software system and method.

### BACKGROUND

Software systems are well known. One example of a software system is a customer relationship management (CRM) system and solution. For example, typical known CRM systems include Microsoft® CRM, SalesForce, a CRM product provided by SalesForce.com, Netsuite CRM, and SAP Business One CRM. However, conventional CRM systems have significant limitations that include a lack of flexibility, high costs, and a closed-source structure which is embedded into the traditional product offerings. These systems also do not have metadata driven user interface capabilities. These limitations have led to a failure rate of over 70% with traditional CRM implementations. Thus, it is desirable to provide a metadata driven user interface system and method.

### BRIEF DESCRIPTION OF THE DRAWINGS

FIG. 1A is a diagram illustrating a customer relationship management system that may incorporate a metadata driven user interface system and method;

FIG. 1B illustrates more details of the customer relationship management system that incorporates the metadata driven user interface system and method;

FIG. 2 is a diagram illustrating an example of the user interface of the system in FIGS. 1A and 1B;

FIG. 3 illustrates an example of a schema for a tracker module of a business application such as a customer relationship management system;

FIG. 4A-4H illustrate several examples of the graphs and charts that may be displayed by the CRM system shown in FIGS. 1A-2 as well as the drill downs for the application;

FIGS. 5A-5E illustrate the details of an access control list that is part of a security module of the system;

FIGS. 6A-6K illustrate details of a module builder unit of the system; and

FIG. 7 illustrates a shared folder of the system.

### DETAILED DESCRIPTION OF ONE OR MORE EXEMPLARY EMBODIMENTS

The system is particularly applicable to an open source-based customer relationship management software system and it is in this context that the system will be described. It will be appreciated, however, that the system and method has greater utility since it may be used with any software system or any implementation and is not limited to the implementation described below. For purposes of illustration, however, the described system is an implementation in a customer relationship management (CRM) and groupware system. In the example, the CRM and groupware system is SugarCRM Inc.'s Sugar Enterprise 5.0.

The system may be implemented in a preferred embodiment using a base class known as SugarBean, and a data retrieval API. The base class has methods for building list queries, saving, and retrieving individual items. Each specific type of data creates a subclass of this base class. In a preferred embodiment of the invention, the base class is called SugarBean. There is at least one subclass of SugarBean for each module. SugarBeans also are used for creating database tables, cleaning out database tables, loading records, loading lists, saving records, and maintaining relationships. One example of a SugarBean subclass is Contact. Contact is a simple object that fills in some member variables on the SugarBean and leverages SugarBean for much of its logic. Security for instance, is automatically created for Contact. Another example of a SugarBean subclass is Users which is a module that is security related and should not have row level security applied to them. For this reason these modules have the bypass flag set to skip adding the right join for verifying security. The SugarCRM Sugar Professional system is a web based system with many concurrent users. Since this program contains critical data to the users, it is imperative that they have quick access to the system and their data. The most frequent activity in the program is to look at existing data.

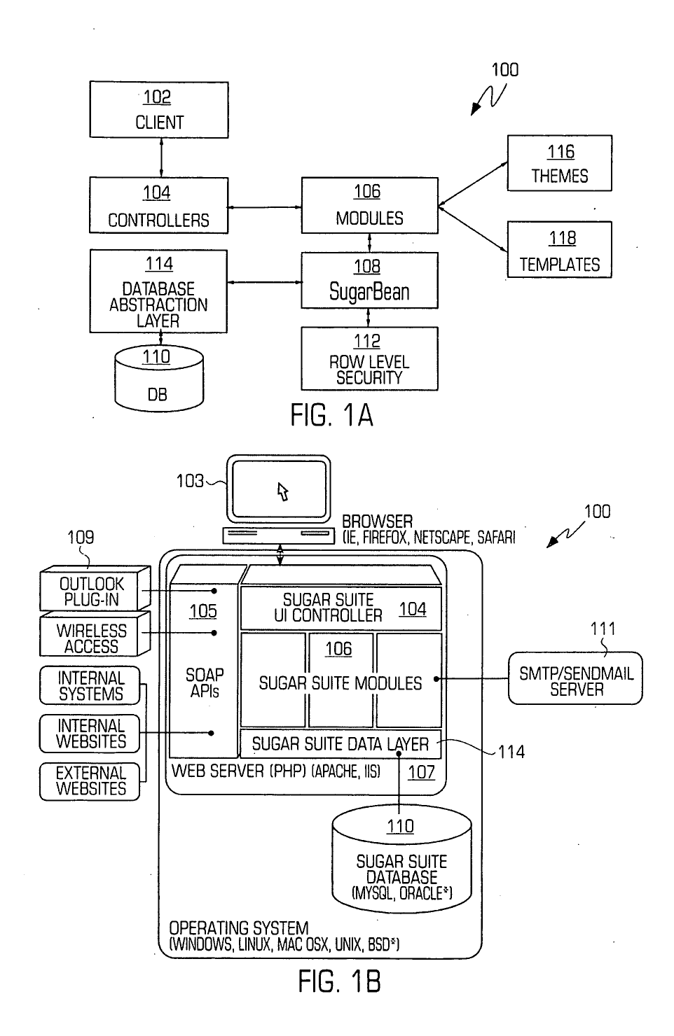

FIG. 1A is a diagram illustrating a customer relationship management (CRM) system 100 that is an example of a software-based business software application in accordance with the invention. In a preferred embodiment, the system 100 in accordance with the invention is implemented as a software system and the elements shown in FIG. 1 are thus implemented as a plurality of lines of computer code that may be executed by a processor of a computer system, such as a server computer wherein the various lines of computer code are stored in a memory associated with the computer system and the system interfaces with a database 110. The system may have one or more clients 102, such as a browser application executed on a typical computing device (a browser client session), that accesses the system over a communications network 103 such as the Internet, a cellular network, a wireless network and the like. The computing devices may include a laptop, table or desktop computer system, a PDA, a mobile phone, a portable wireless email device and the like. The client 102 interactions go through a set of one or more controllers 104. The controllers are the entry-point into the system and take care of things like session tracking, session security and end user authentication. The controllers also take care of the work to prepare the screen or the wrapper for the content and determine which module of the application the user is trying to access and get the requested module to process the request. The system thus has one or more modules 106 that are components of application functionality and provide certain functionality. The modules 106 of the exemplary CRM system shown in FIG. 1A may include, by way of example, a portal module, a calendar module, an activities module, a contacts module, an accounts module, a leads module, an opportunities module, a quotes module, a products module, a cases module, a bug tracker module, a documents module, an emails module, a campaigns module, a project module, an RSS module, a forecasts module, a reports module and a dashboard module. In accordance with the invention, the system may include different, more or fewer modules and the systems with those other combination of modules are within the scope of the invention. Each of these modules provides a different functionality to the system so that, for example, the calendar module provides a calendaring functionality to the CRM system that is instantiated with the system. The system may also include an administration module that handles the typical administrative functions of the system. Each module contains a subclass of a SugarBean base object 108 and each module references the SugarBean to retrieve the data from the database 110 required for display.

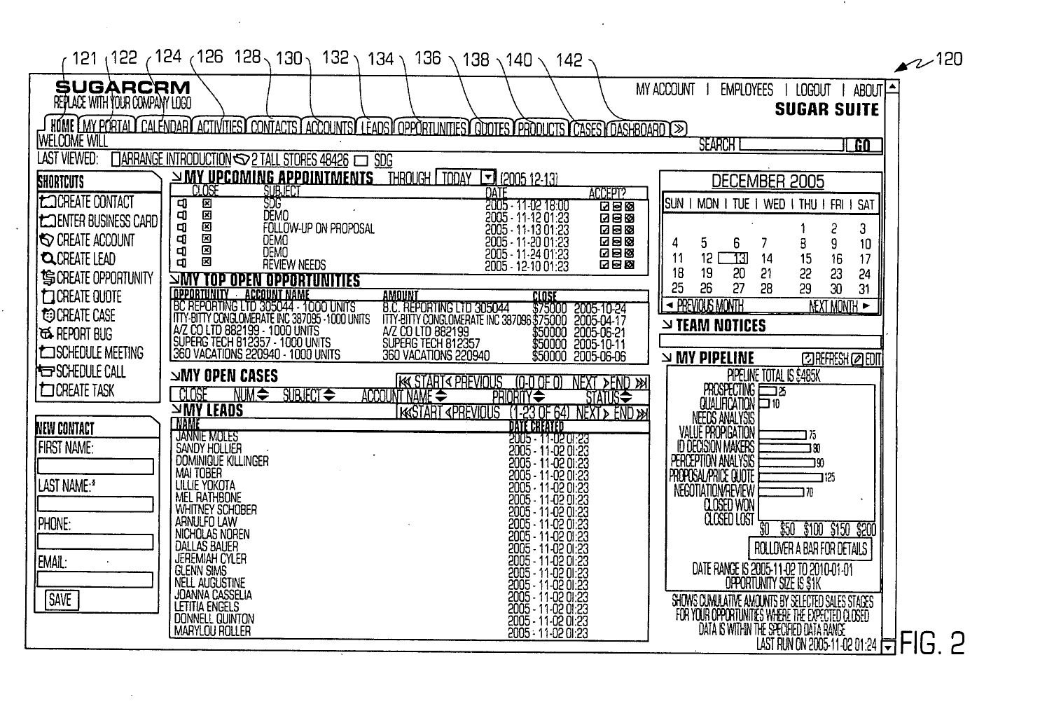

FIG. 2 is a diagram illustrating an example of the user interface 120 of the system in FIG. 1A. The user interface may include a home tab 121 that provides a general overview of Cases, Opportunities, Appointments, Leads, Tasks, Calendar, Team Notices, and Pipeline. The home tab also includes shortcuts to enter various different types of data, and a quick form for new contacts. The home tab also provides a quick overview of what customer tasks and activities that the user needs to focus on today. The portal module (selected using a “My portal” tab 122), contains a series of shortcuts which can link to any web site chosen by the user that may include e-mail, forums, or any other web-based application, allowing the system to become a single user interface for multiple applications. The calendar module may be selected by a calendar tab 124 and allows the user to view scheduled activities (by day, week, month or year), such as meetings, tasks, and calls. The system also allows the user to share his/her calendar with coworkers which is a powerful tool for coordinating the daily activities. The activities module is selected using an activities tab 126 and allows the user to create or update scheduled activities, or to search for existing activities. By managing Activities within the context of an Account, Contact, Lead, Opportunity, or Case, the system allows the user to manage the myriad of calls, meetings, notes, emails and tasks that the user needs to track in order to get the job done. The tasks are for tracking any action that needs to be managed to completion by a due date, the notes allow the user to capture note information as well as upload file attachments, the calls allow the user to track phone calls with leads and customers, meetings are like calls, but also allow the user to track the location of the meeting and emails allow the user to archive sent or received email messages.

The contacts module is accessed by a contacts tab 128 and allows the user to view a paginated contact list, or search for a contact. The user can click on a specific contact to zoom in on the detailed contact record and, from a specific contact record, the user may link to the related account, or leads, opportunities, cases, or direct reports (related contacts). Within the system, contacts are the people with whom the organization does business. As with accounts, the system allows the user to track a variety of contact information such as title, email address, and other data. Contacts are usually linked to an Account, although this is not required. The accounts module may be accessed using an accounts tab 130 and the user may view a paginated account list, or search for an account. The user can click on a specific account to zoom in on the detailed account record and, from a specific account record, the user may link to related contacts, activities, leads, opportunities, cases, or member organizations. Accounts are the companies with which the organization does business and the system allows the user to track a variety of information about an account including website, main address, number of employees and other data. Business subsidiaries can be linked to parent businesses in order to show relationships between accounts.

The leads module may be accessed by a leads tab 132 that permits the user to view a paginated list of leads, or search for a specific lead. The user can click on an individual lead to zoom in on the lead information record and, from that detailed lead record, the user can link to all related activities, and see the activity history for the lead. Leads are the people or companies with whom the organization might do business in the future. Designed to track that first point of interaction with a potential customer, leads are usually the hand off between the marketing department and the sales department. Not to be confused with a contact or account, leads can often contain incomplete or inaccurate information whereas contacts and accounts stored in Sugar Professional are core to many business processes that require accurate data. Leads are typically fed into the Sugar Professional system automatically from your website, trade show lists or other methods. However, the user can also directly enter leads into Sugar Professional manually.

The opportunities module is accessed by an opportunities tab 134 and permits the user to view a paginated list of opportunities, or search for a specific opportunity. The user can click on an individual opportunity to zoom in on the opportunity information record and, from that detailed opportunity record, the user can link to all related activities, see the activity history for the opportunity, and link to related leads and contacts. Opportunities track the process of selling a good or service to a potential customer. Once a selling process has commenced with a lead, a lead should be converted into a contact and possibly also an account. Opportunities help the user manage the selling process by tracking attributes such as sales stages, probability of close, deal amount and other information. The quotes module may be accessed by a quotes tab 136 and permits the user to view a paginated list of customer quotes, or search for a specific quote. The user can click on an individual quote to zoom in on the detailed quote information. A quote is formed by referencing product and pricing from a catalog of products you may create. A presentation quality Portable Document Format (PDF) representation of the quote may be created to fax or email to a client. Quotes may be associated with Accounts, Contacts, or Opportunities.

The products module may be accessed by a products tab 138 and permits the user to view a paginated list of products, or search for a specific product. The user can click on an individual product to zoom in on the detailed product information. A product is used when assembling a customer quote. The cases module may be accessed using a cases tab 140 and may permit the user to view a paginated list of cases, or search for a specific case. The user can click on an individual case to zoom in on the case information record and, from that detailed case record, the user can link to all related activities, see the activity history for the case, and link to related contacts. The cases are the handoff between the sales department and the customer support department and help customer support representatives manage support problems or inquiries to completion by tracking information for each case such as its status and priority, the user assigned, as well as a full trail of all related open and completed activities. A dashboard (such as that shown for example in FIG. 2) module may be accessed using a dashboard tab 142 and permits the user to view a dashboard of the information in the CRM system.

The documents module may show the user a list of documents that the user can download. The user can also upload documents, assign publish and expiration dates, and specify which users can access them. The email module allows the user to write and send emails and to create Email Templates that can be used with email-based marketing campaigns. The user can also save drafts and archive emails. The campaigns module helps the user implement and track marketing campaigns wherein the campaigns may be telemarketing, mail or email based. For each Campaign, the user can create the Prospects list from the Contacts or Leads or outside file sources. The projects module helps the user manage tasks related to specific projects. Tasks can be assigned to different users and assigned estimated hours of effort and, as tasks are in progress and completed, users can update the information for each task. The RSS module permits the user to view the latest headlines provided by your favorite Really Simple Syndication (RSS) feeds. These feeds provide news or other web content that is distributed or syndicated by web sites which publish their content in this manner. The system has hundreds of RSS feeds available as supplied, and others may easily be added.

The forecasts module shows the user his/her committed forecast history and current opportunities. For managers, the user can view your team's rolled up forecasts. The reports module shows the user a list of saved custom reports not yet published, as well as a list of Published Reports. Saved reports may be viewed, deleted or published, and published reports may be viewed, deleted or un-published. Clicking on the name of a report zooms to the detailed definition of the report criteria (fields to be displayed, and filter settings) for that report, permitting the user to alter the criteria, and re-submit the report query. Finally, the dashboard module displays a graphical dashboard of the user's Opportunity Pipeline by Sales Stage, Opportunities by Lead Source by Outcome, Pipeline by Month by Outcome, and Opportunities by Lead Source.

Returning to FIG. 1A, the system also includes the database 110 that contains the data of the system and a security module 112 that implements the security methods to control access to the data in the database 110. The system may also include a database abstraction layer 114 that is coupled between the database 110 and the SugarBean object 108 in order to be an interface between the database 110 and the SugarBean object 108. The SugarBean object 108 provides the base logic required for retrieving and making available information from the database and each module creates subclasses of SugarBean to provide module specific details. During the process of retrieving data from the database, the SugarBean 108 makes calls that populate the row level security information into the SQL that retrieves the data.

Once the data is retrieved from the SugarBean object 108, the module uses a template mechanism 118 and a theme 116 to produce the requested presentation for the user. The template mechanism reformats the data from the database 110 into a particular form while the theme adjusts the user interface according to the user's preferences. If, for instance, the user requests an HTML presentation of the detail view of the contact module for a specified contact, here is the flow of what happens. The user hits the entry point named index.php. The entry point then loads the controller. The controller handles most of the logic for the main application. The controller loads the current user, verifies authentication and session information, loads the language for the user and produces some of the user interface shell. The controller then calls the contact module and request the detail view for the specified contact. The contact module retrieves the SugarBean for the requested contact. The SugarBean verifies row level security at this point. If the record is not retrieved successfully, then the process aborts and the user is not allowed to view the data for the record. If the retrieve process succeeds then it uses the XTemplate mechanism and the code for the current user's theme to create the user interface for presentation. The resulting user interface is sent back to the client that requested it.

FIG. 1B illustrates more details of the customer relationship management system 100. Like elements shown in FIGS. 1A and 1B have like reference numerals. The system may interface with a typical browser application 103 (being executed by a computing device) that can access the system 100 over the web. For example, the examples of the user interface below are web-based views generated by the system and displayed on a browser application. The system may further comprise an application programming interface (APIs) portion 105, that may preferably use the well known simple object access protocol (SOAP), to interface with other existing system and applications. For example, the APIs may be used to interface to an email plug-in 109, such as an Outlook plug-in, that permits the system 100 to interact with the email program. As shown, the system 100 is preferably implemented on a web server application 107 (that may preferably be the well known Apache web server that includes IIS functionality) that generates dynamic web pages (PHP). The web server and the other elements of the system may be implemented as software running on one or more servers wherein the servers may use various different operating system as shown in FIG. 1B. The system 100 may also interface with an SMTP/sendmail server 111. As an example, the CRM system described above may incorporate the metadata driven user interface system and method and the implementation of the metadata driven user interface system within the above CRM system is described for illustration purposes although the metadata driven user interface system and method can be implemented in any software system.

### Tracker

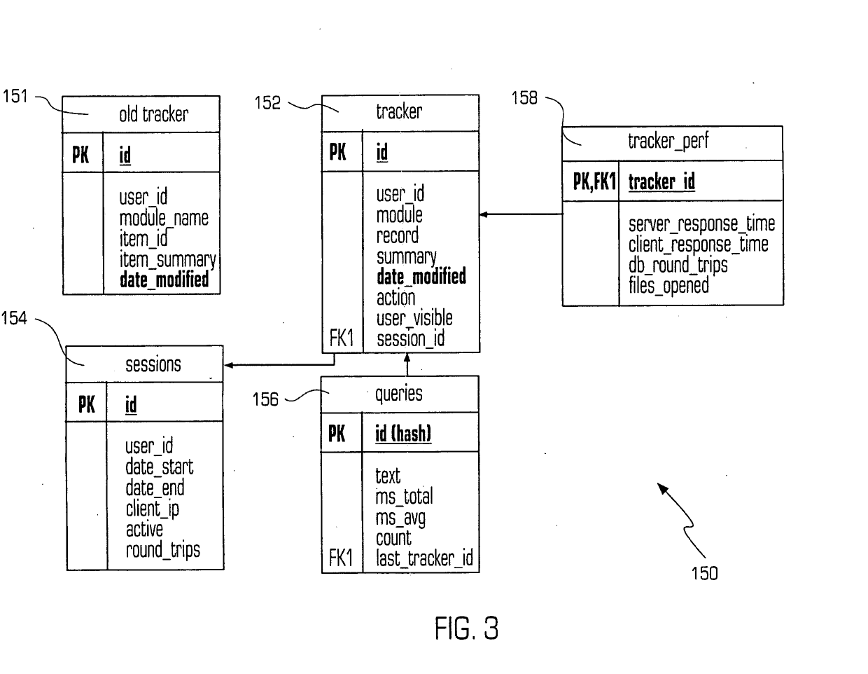

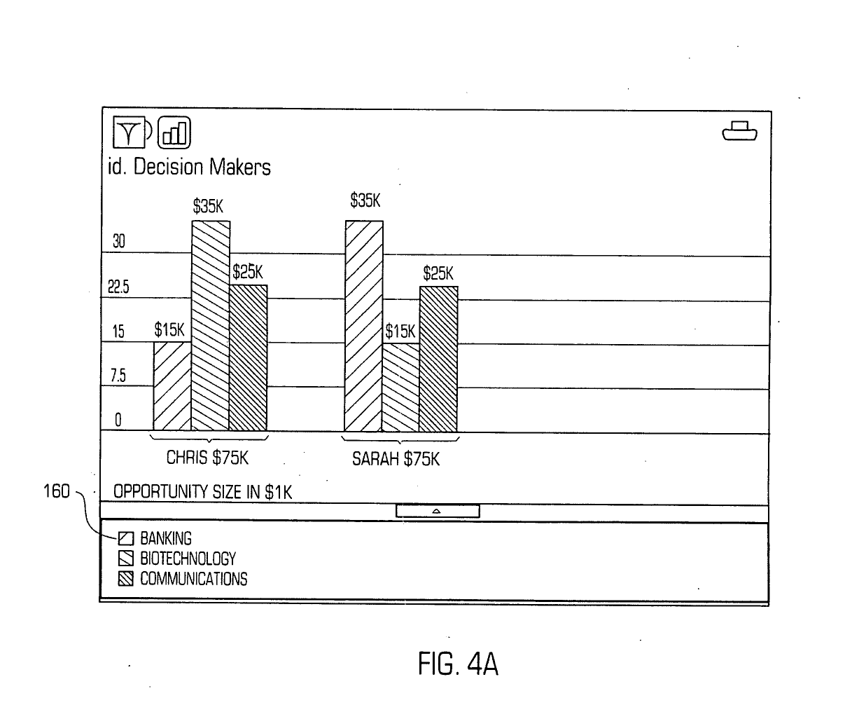

FIG. 3 illustrates an example of a schema 150 for a tracker module of a business application such as a customer relationship management system. The tracker module, that may be one of the Sugar Suite modules 106 shown in FIG. 1B, may monitor the performance of the system, provide an audit trail, track performance issues, identify poorly performing queries, improve heartbeat reporting and provide module level usage statistics.

The schema 150 shown in FIG. 3 may include a tracker table 152, a sessions table 154, a queries table 156 and a tracker performance table 158. A prior version of the tracker schema 151 is also shown. The schema 150 allows the tracker to track every transaction to/from the database (roundtrips), all sessions, all queries, every login attempt, etc . . . The tracker module may then be used as an enterprise grade management tool that allows people with the proper authority and access levels to view data on usage levels, a history of what records were viewed, find out who performed what action, etc.

The sessions table 154 may be used to track all sessions of the CRM system or any other business application. The table is used to store and/or find all currently logged in users and display that information in the application. The table may also contain information about the number of round trips to the database performed and files included during a particular server round trip. The table may also track where the session came from (the client IP address), when it started, and when it ended. All of this information can be made available in a display to the authorized user. This information will be very useful to track issues back to their source, track possible intrusions, and validate system usage.

The queries table 156 may be used to track all queries submitted to the database. The table can log all queries, or just the queries that meet a “slow query log” criteria. Slow queries are typically defined as queries that either use too many resources, do not leverage the database efficiently, return too much data, or take more time than they should. The criteria for each of these measurements may be configurable (how much data is too much, how long is too long, . . . ). The “slow query log” is a better medium for tracking slow queries than the log file and it collects all of the data in the database where it is easy to perform an analysis on it. The queries table 156 may also track the number of times a query was executed (count), the total milliseconds that all occurrences have taken (ms total), and the average time that the query has taken (ms avg). The information within this table may be retrievable from within the application in an enterprise performance console. The information in this table will be most useful if the queries are prepared statements. Prepared statements are queries that have all of the constant values removed from them and passed to the database separately which means that the analysis performed for the database to determine how to effectively perform the query only needs to be done once. Prepared statements also mean that the queries executed will be more likely to match. If you have 10,000 queries retrieving 9,000 distinct contacts, with prepared statements there will be 10,000 calls to 1 prepared statement. Without prepared statements there will be 9,000 distinct queries. When analyzing the database usage, it is much easier to see how much time is spent retrieving contacts when one consolidated query is listed.

The tracker_perf table 158 may track performance related data. For most installations of the system, it is an optional action and, if enabled and coded properly, it tracks the server side statistics that show up on the screen, and the client side performance. The server side data is already captured by the controller and is easy to store. The client side information may be captured using javascript. For example, a simple timer on the client side (or just a callback to the server at the bottom of the page) may be implemented and the table can track how quickly the rendering is completing on the client side. The client side performance information, combined with the other information that is being tracked will allow the system or an authorized user to quickly determine if there is a pattern of poor client side performance.

The tracker table 152 tracks user ID, the module being accessed and the record being accessed as well as a session id that created the entry and if the item should be user visible as a bread crumb in the application. This information allows the authorized user or the system to track AJAX calls, login attempts, logins, saves, deletes, . . . without cluttering the user's experience.

Since the tracker module is tracking round trips to/from the database, the data stored by the tracker is not deleted on every round trip, but may be periodically cleaned during normal system maintenance. The minimum cleanup ability may be to remove all tracker entries older than a specified date which can be done by finding the last tracker ID that is old enough to be deleted and then delete all the IDs on or before that last tracked ID.

The data captured by the tracking module may be used to calculate and/or display module specific usage information in heartbeats, more accurate usage information in heartbeats (number of sessions, number of round trips, . . . ), query Performance reporting and/or tuning, performance monitoring and reporting (show graphs of system performance over time, report issues via email if the server is running slow, . . . ), show usage information to managers and system administrators, track adoption rates and/or add “who's online” into the application. One example report would be to show the average amount of deals closed per operation performed in the CRM system. If a correlation is present, this is a clear incentive to encourage usage of the CRM system. Another report can show module usage by representative by day. This shows how well the users are adopting the system.

### Drill Downs

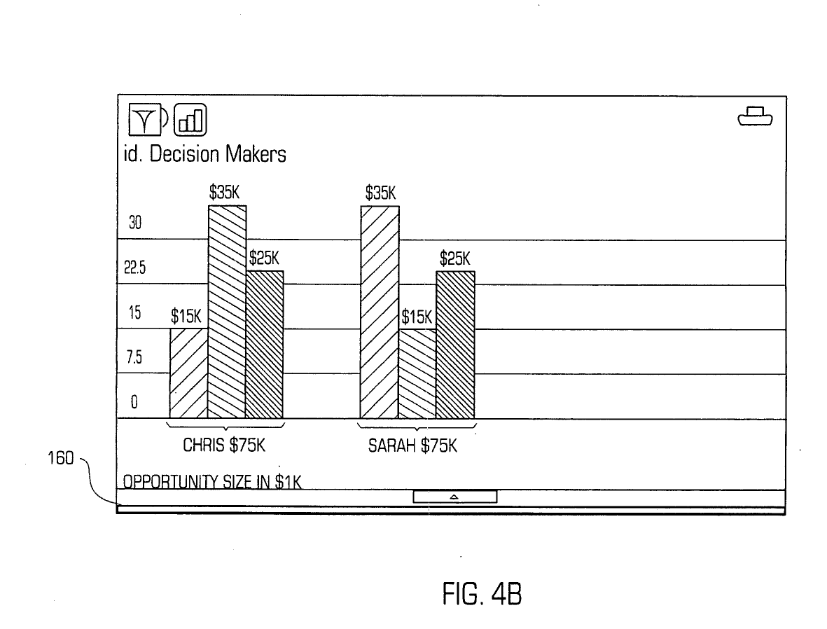

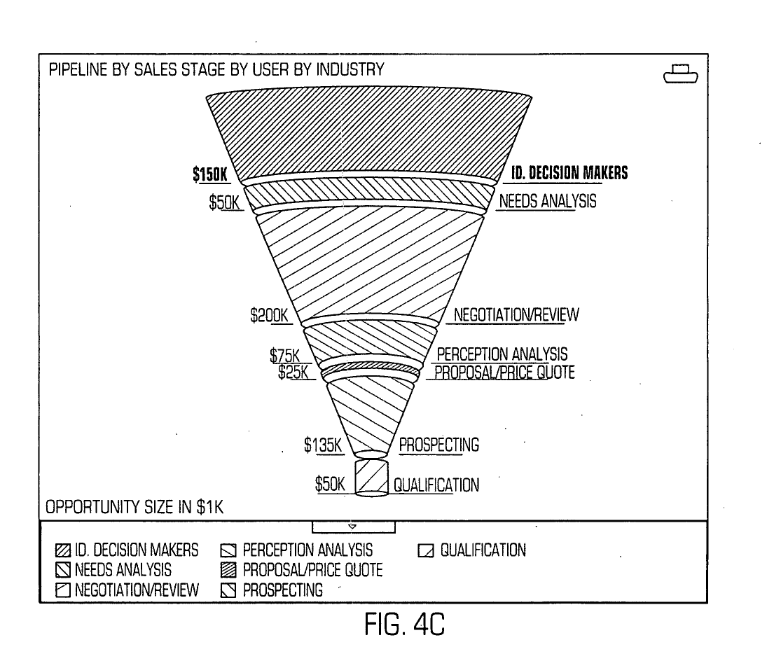

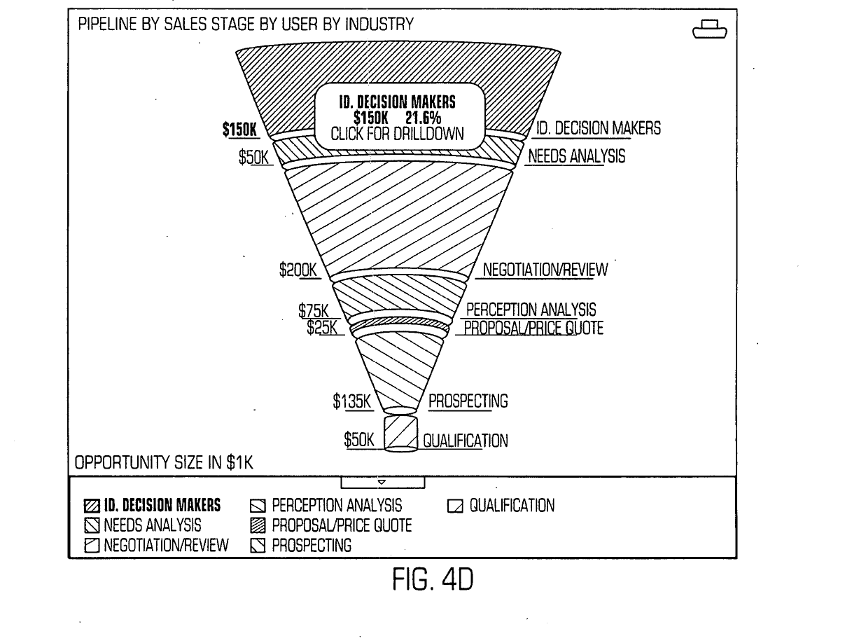

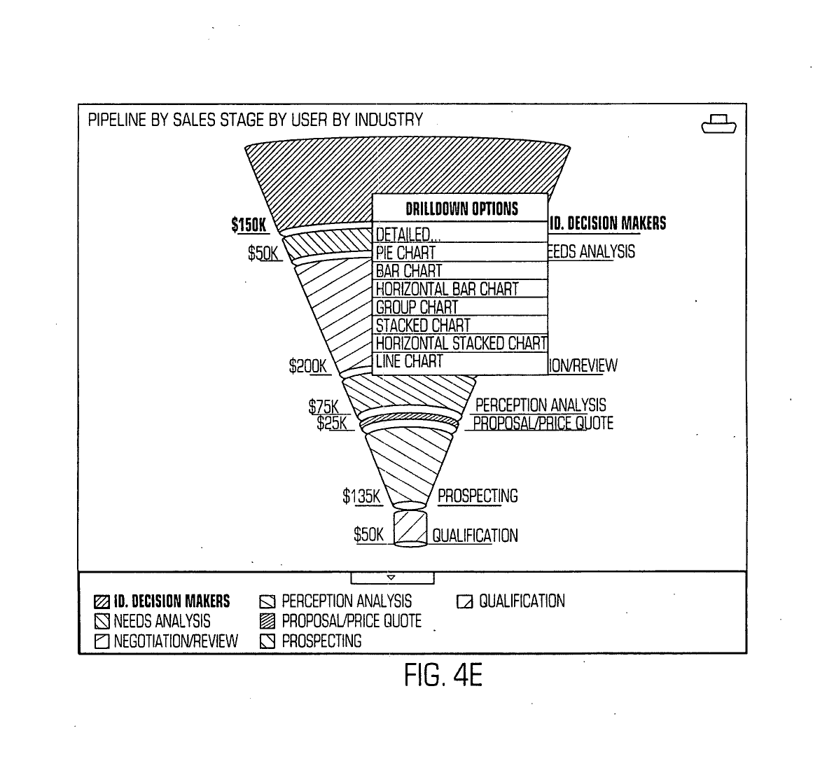

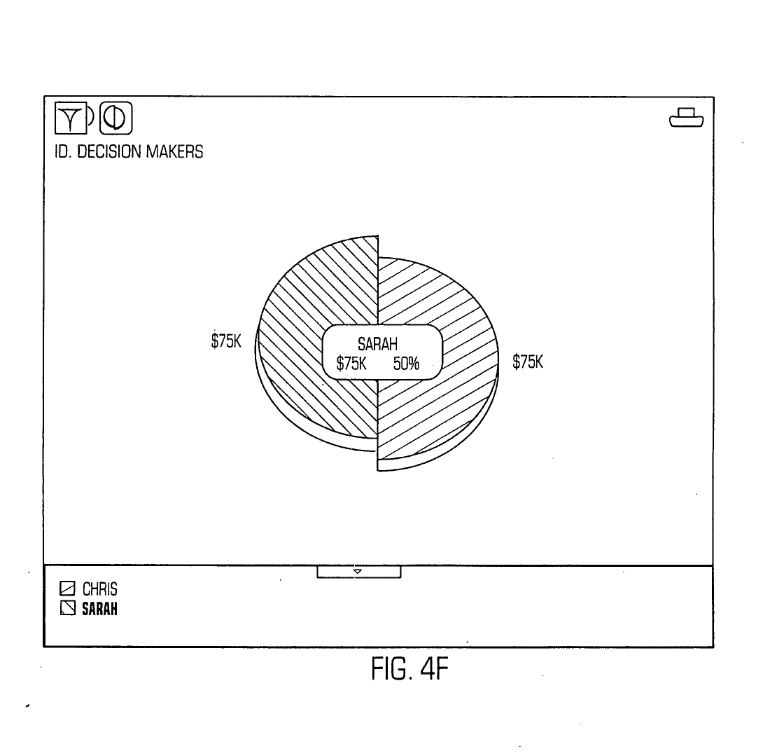

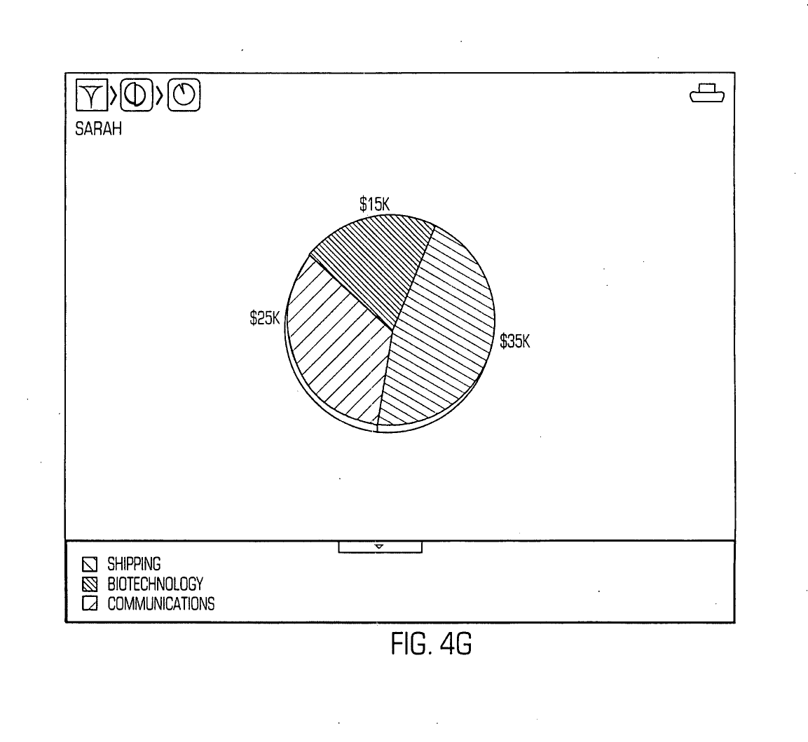

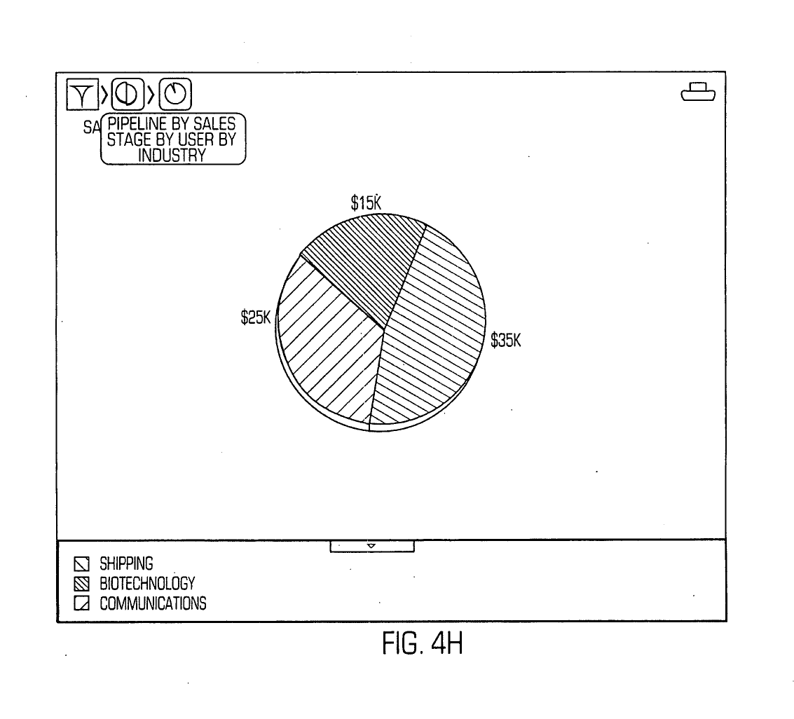

FIG. 4A-4H illustrate several examples of the graphs and charts that may be displayed for the CRM system shown in FIGS. 1A-2 as well as the drill downs for the CRM application. Many of the existing systems provide end user graphs and charts, but the graphs and charts are less intuitive for user to navigate through the data. A reporting module (that is part of the modules 106) may generate more intuitive graphs and/or charts (with deeper drill down) and may use a tool, such as Adobe® Flash, to implement these charts and/or graphs. As shown in FIG. 4A, each graph and/or chart may include a legend section 160 that is viewable by the user of the system. This section may show the user what look/screen display/color has been assigned to each type of data. If this section is present, it may also have control that allows for it to be hidden or collapsed. It may also automatically show itself if the user hovers near where it is collapsed. FIG. 4A shows what the graph may look like when the legend is present at the bottom of the graph while FIG. 4B shows what the graph may look like when the legend is collapsed.

The system may support multiple looks, which may include but are not limited to, colors, multiple color palates, black and white patterns, colored lines, graphical images (stretched, tiled, or centered), words, or any other means to distinguish between items or show one item. The system may support showing more information about sections of the graph when the user hovers their mouse over that section. For example, as shown in FIG. 4C, a graph that shows a sales pipeline. Now, when the user hovers the mouse over the top section, a summary of that section appears on the screen as shown in FIG. 4D. This provides more detailed information than may be present in the standard graphical representation. The system also may support allowing the user to click on a section of a graph and drill down into the list of data that composes that graph. For example, if the user clicks on the first section in FIG. 4C, the user will see the user interface presented in FIG. 4D. If the user clicks on “Detailed . . . ” they will be presented with the list of just the data that was used to compose that portion of the graph. In this case, it will be a list of opportunities that are in the “Id. Decision Makers” sales stage.

In addition to the features that the graph has for a single layer of data, the graph may contain multiple layers of data. If the user clicks on the top item from FIG. 4C, there may be a bunch of options that will present options for graphing more details about the section that was selected (FIG. 4E). If the user selects the “Pie Chart” option from FIG. 4E, they may see a further graph that shows the composition of that section as shown in FIG. 4F. This graph is showing that half of the deals in this sales stage are owned by each of the users. Clicking on the left hand side and selecting “Pie Chart” again produces FIG. 4G which shows the industries for the deals that composed the left hand side of FIG. 4F.

The system may also contain a legend of where the user has been to allow them to quickly navigate back through to higher levels of the graph. From FIG. 4G, the user sees in the upper left hand side of the graph a list of three icons. Each of the icons represents one of the graphs that was navigated to get to the current view. The history icons may have text that explains what they contain when the user hovers over them (FIG. 4H is the user interface when the user is hovering over the upper left icon). The history icons may also be click able to allow the user to quickly navigate back to a previous graph.

At each level, the user may have multiple chart options available. In one embodiment, going back to original graph as shown in FIG. 4C, the user can click on the top item and select “Group Chart”. This will show a graph like the graph in FIG. 4H. The system may also contain a print icon on the graph that allows the user to print the graphs out for later reference. FIG. 4G shows an example of a user interface that contains a sample icon in the upper right that allows users to print. The system may be developed to efficiently transmit data to the client. It may either send multiple levels of data all at once, or send additional data as the user clicks. This decision may be arbitrary or based on the size of the data to transmit.

This graphing system may allow for unlimited levels of drilling down. While the example described only went down 2 levels, there is no restriction on the number of levels supported.

### Access Control Lists

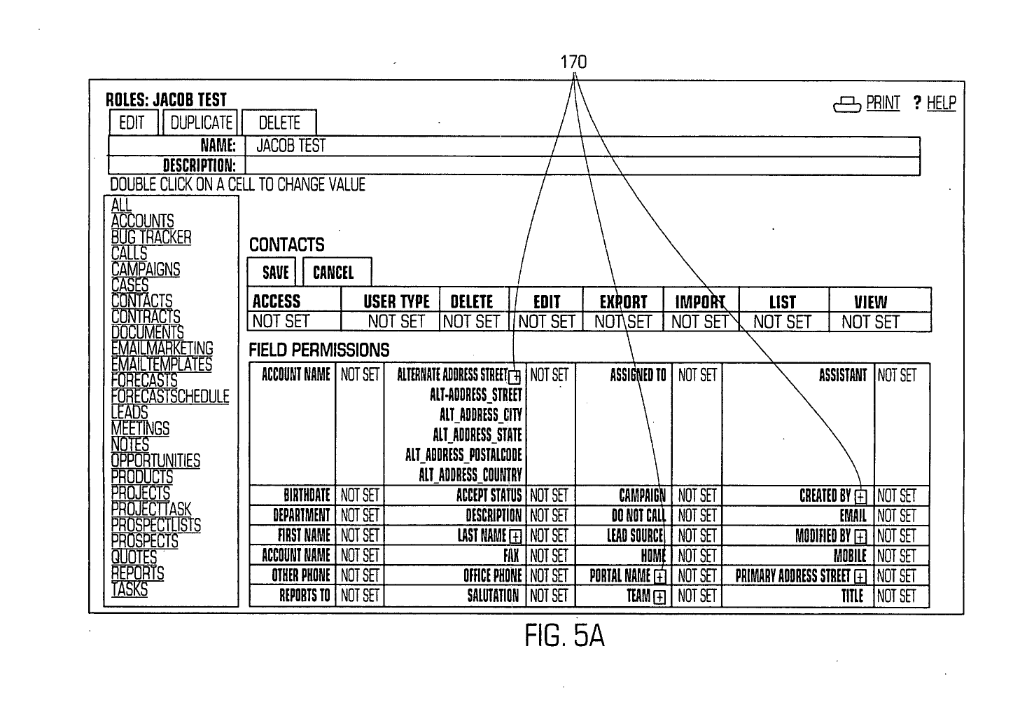

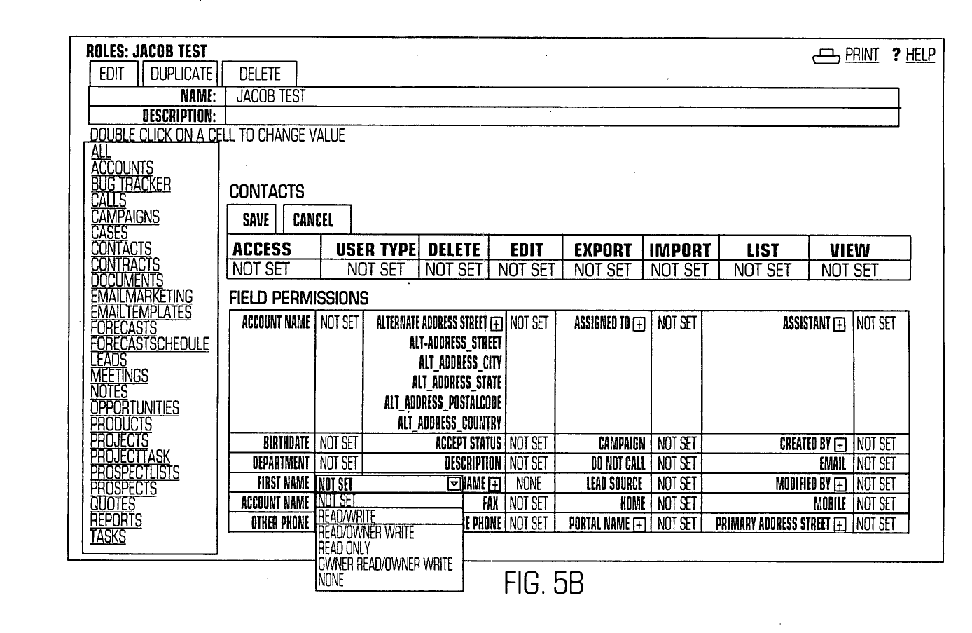

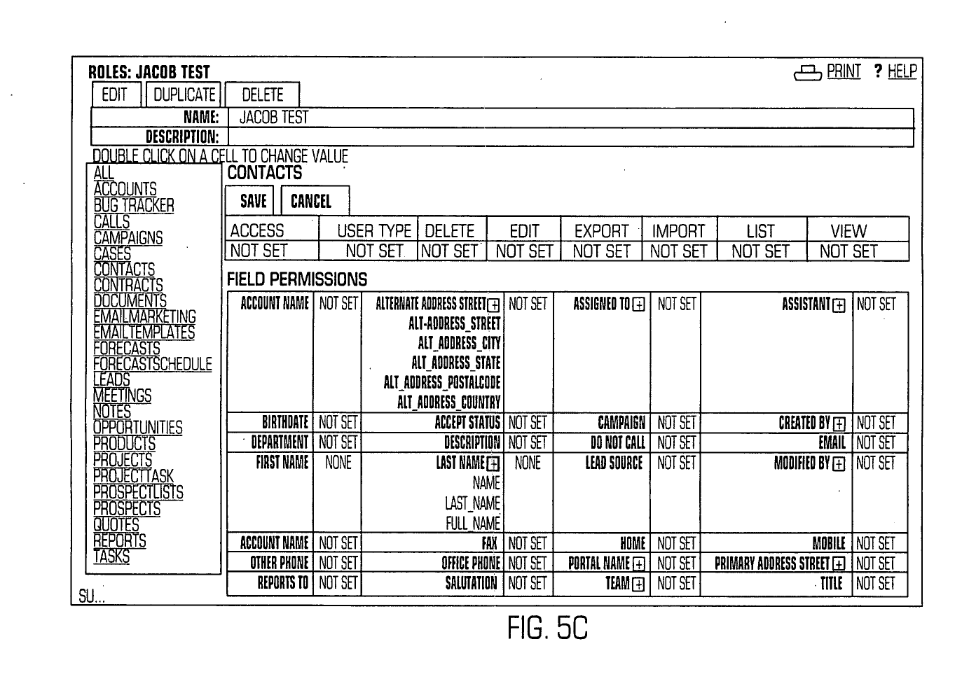

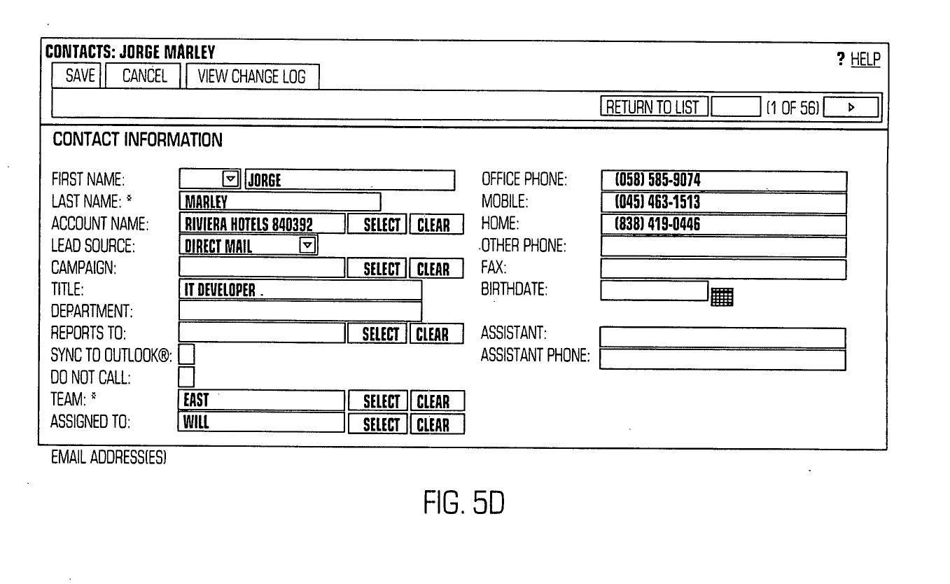

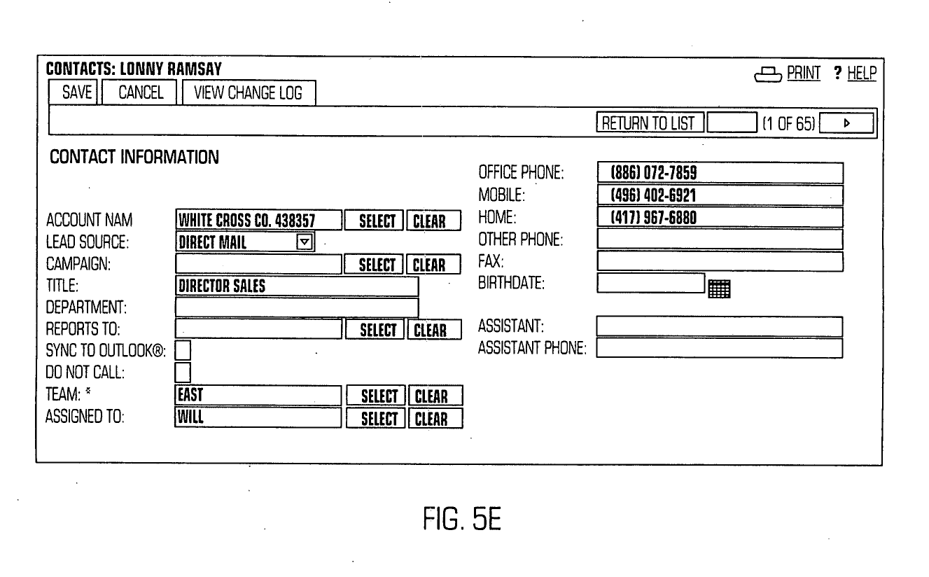

FIGS. 5A-5E illustrate the details of an access control list that is part of a security module of the system. It is desirable to be able to manage which users can view what fields among the records in the database 110 using access control lists. The system may include a security module that is part of the modules 106 of the system as shown in FIG. 1B that has the ability to limit access to specific fields. The mechanism for controlling this feature may be tied to user permissions, layout, or other systems. In one embodiment, the field level access restrictions are tied to user roles. A sample screen for editing a user role is shown in FIG. 5A. The system may contain field level permissions which allow for multiple possible designations per field. The system may also contain the ability to optionally group fields into relevant groups using a designation 170. In FIG. 5A, this designation is the ‘+’ sign to the right of the label. The system may also optionally allow for expanding the group of fields to show all of the component fields. In FIG. 5A, the “Alternate Address Street” field has been expanded to show alt_address_street, alt_address_city, . . . The system may allow the user to view labels for the fields that are expanded or variable names. In FIG. 5A, the variable names are displayed.

When specifying what actions are allowed for a specific field, the system may allow for a list of possible permissions as shown in FIG. 5B. That list may include but is not limited to: Not Set, Read/Write, Read/Owner Write, Read Only, Owner Read/Owner Write, None. Not Set has no effect on the permissions of the user. Read/Write allows the user permissions to read and write the field. Read/Owner Write allows the user to always see the field but only be able to change it when they own the record. Read Only allows the user to read the field but not change it. Owner Read/Owner Write allows the user to see the field only if they own it and allows them to modify the field only if they own the record. None means that you are not able to see the field.

The definition of record ownership may be based on a property of a record (i.e. assigned user), the property of a related record (i.e. assigned user on the Account a Contact is related to), management hierarchy (i.e. you own the record if someone that reports to you is listed as the owner), group membership (i.e. you a member of the Sales East Group), or any other ownership mechanism that may be derived.

FIG. 5C shows the system after First Name and the group of fields Last Name have both been set to None. FIG. 5D shows an edit view for a contact before his role has been applied to the user. Notice the name fields are present and editable in the UI. FIG. 5E shows the system after the role has been applied to the user and notice that the name fields are gone.

The access control lists of the system may be used for various purposes. For example, the access control lists may be used to control what fields a user has the ability to modify, to hide sales commitments from other users or to allow only an Auditing or Finance group to be able to see and edit credit information without having that information shared with other departments.

Additionally, the system may also support having fields or groups of fields change permissions based on business rules, object state, or other factors. For example, once an opportunity is closed, for instance, only Sales Operations and finance can edit portions of the record and this can be implemented as a field level restriction that is tied to the sales stage of the opportunity.

### Module Builder

It is a common business reality that CRM systems are very heavily customized with the CRM systems typically adapted to the practices and policies of a particular business. In more detail, the CRM system may be modified to match the particular data that an organization wants or needs to collect. The CRM system may also be modified to expand into new areas. For example, Sugar Enterprise 5.0 as a platform is often heavily customized to branch out into new areas. A Module builder unit (that is part of the modules 106 shown in FIG. 1B) is a component that allows business partners, customers, and the community to customize and extend the basic CRM system, such as SugarCRM.

The module builder may be used to create a new module based on pre-defined business entities like Accounts, Contacts, etc. with zero or minimum coding effort, to create modules which appear as sub-panels on other modules, to create a new module from real life business objects like people, processes and transactions, create a new module based on above use cases for an externally accessible portal, such as for example Sugar Portal, to export the modules that are created, to load the new modules in the application with ease, to publish a created module to an online repository that may be a generally accessible marketplace web site for acquiring application modules, such as for example SugarExchange, with ease and/or to have full support of the Sugar platform and related security mechanisms (Teams, Roles, ACLs and Field Level ACLs).

There are frequently many fields that are common among multiple object types. The module builder may include the ability to create new objects or base new objects on either existing objects or on logical portions of objects.

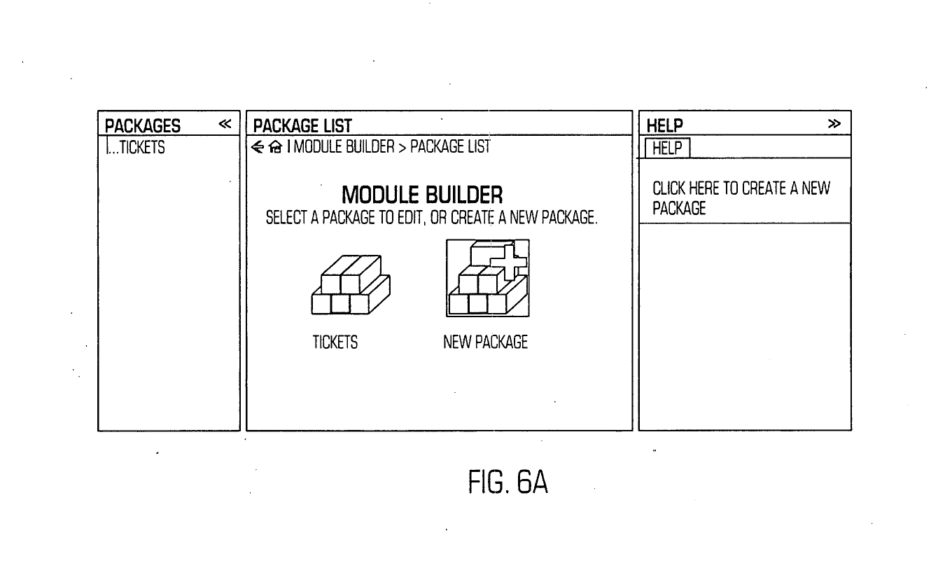

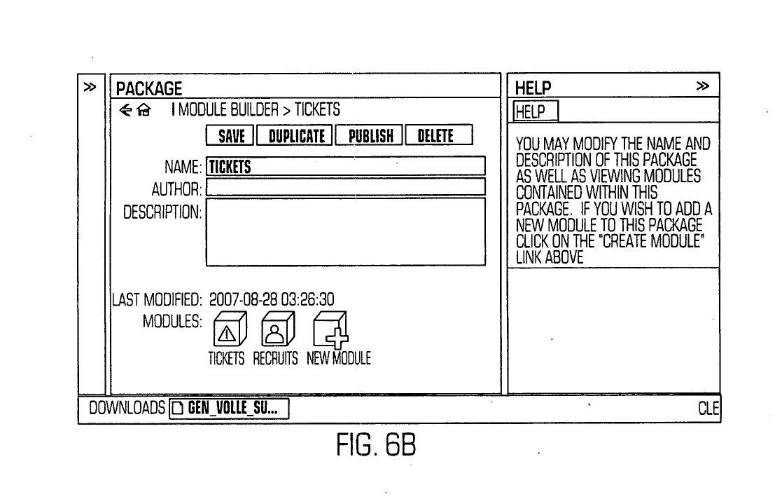

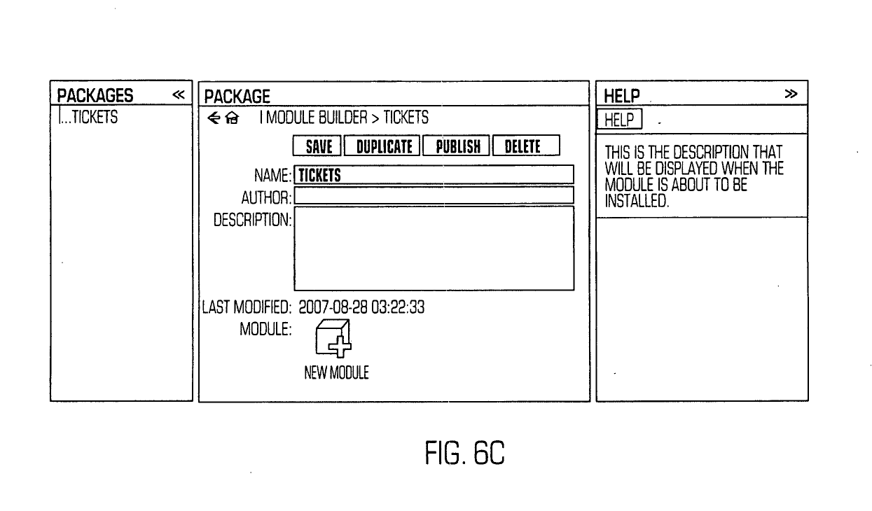

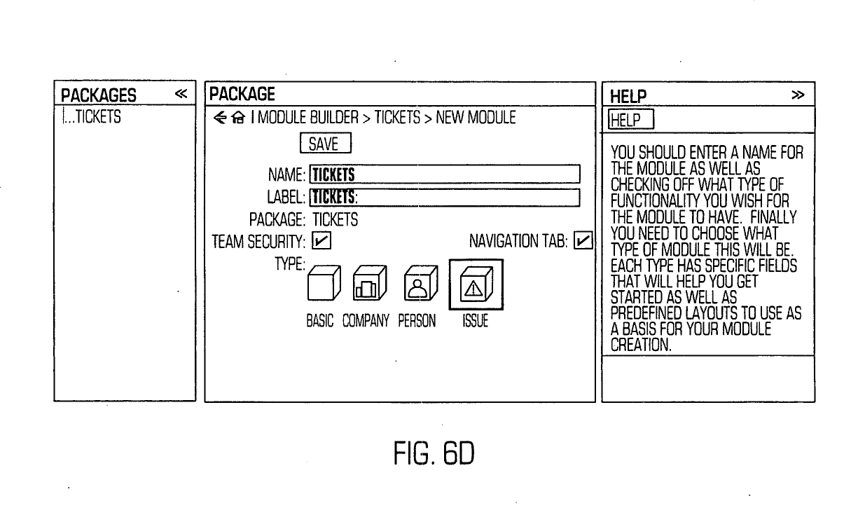

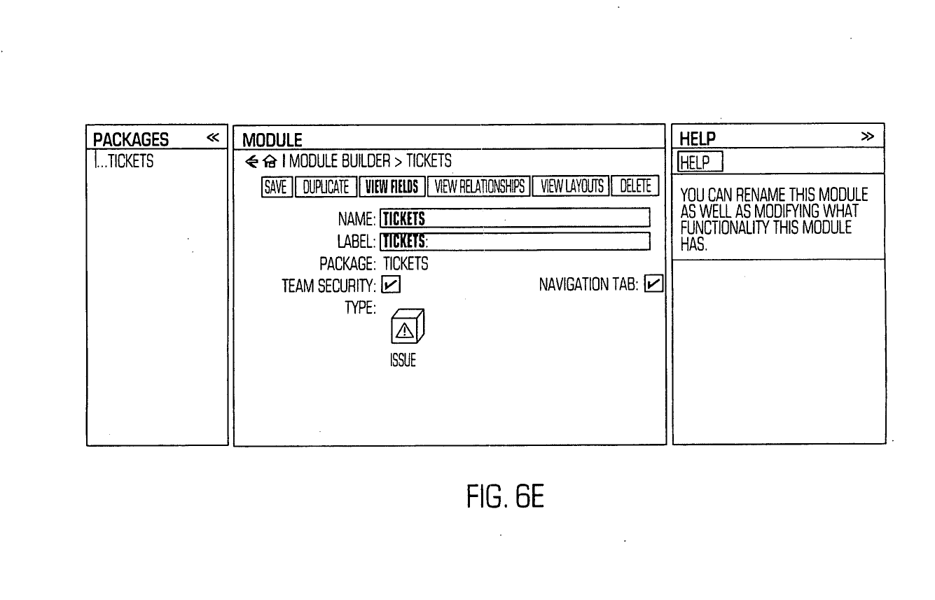

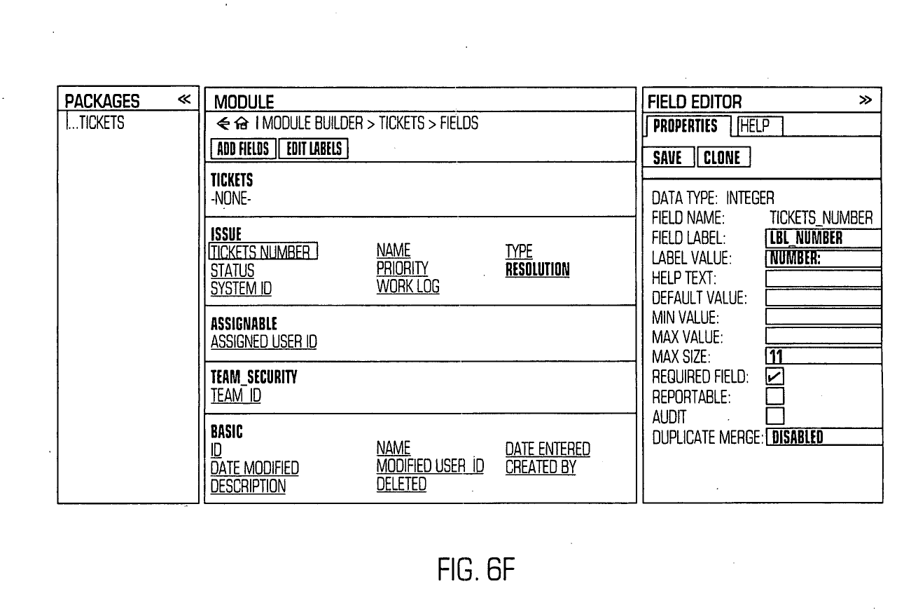

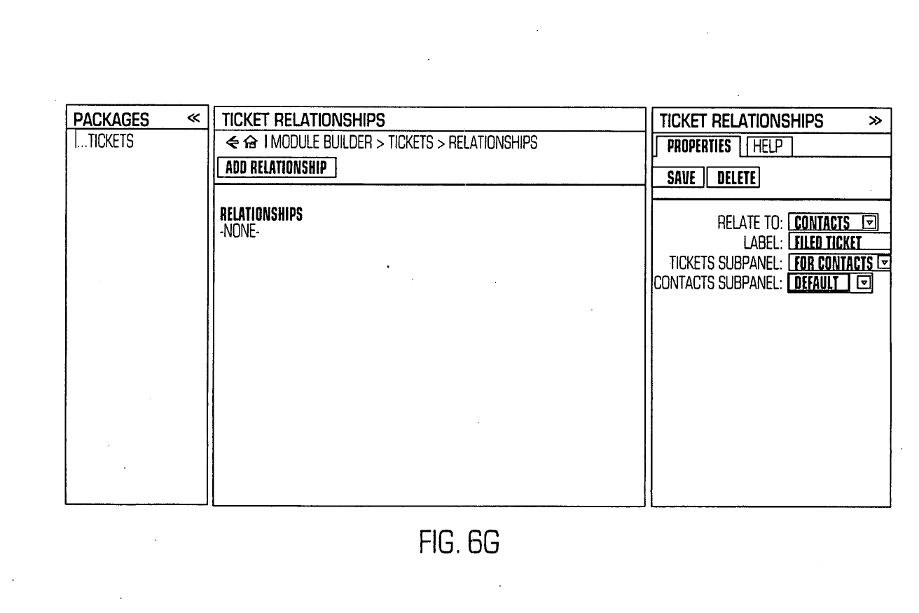

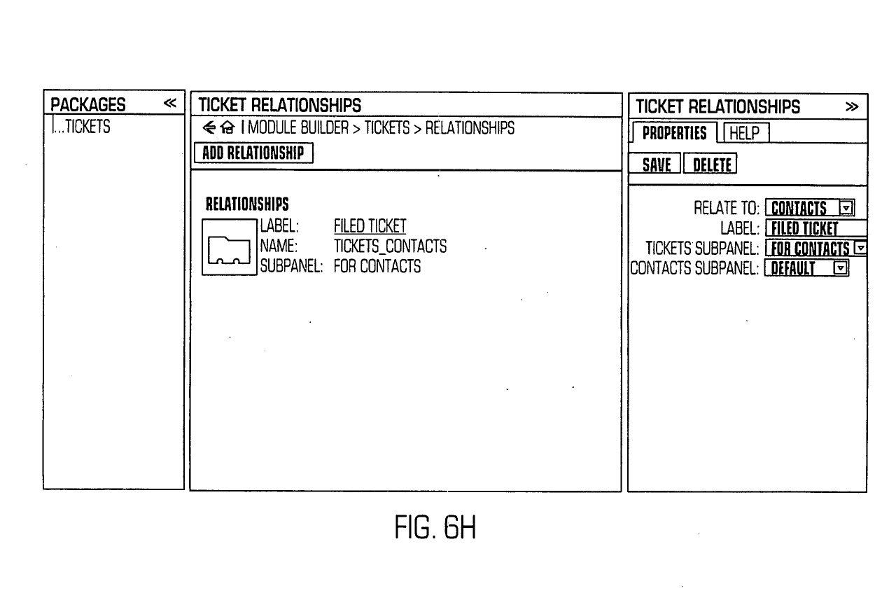

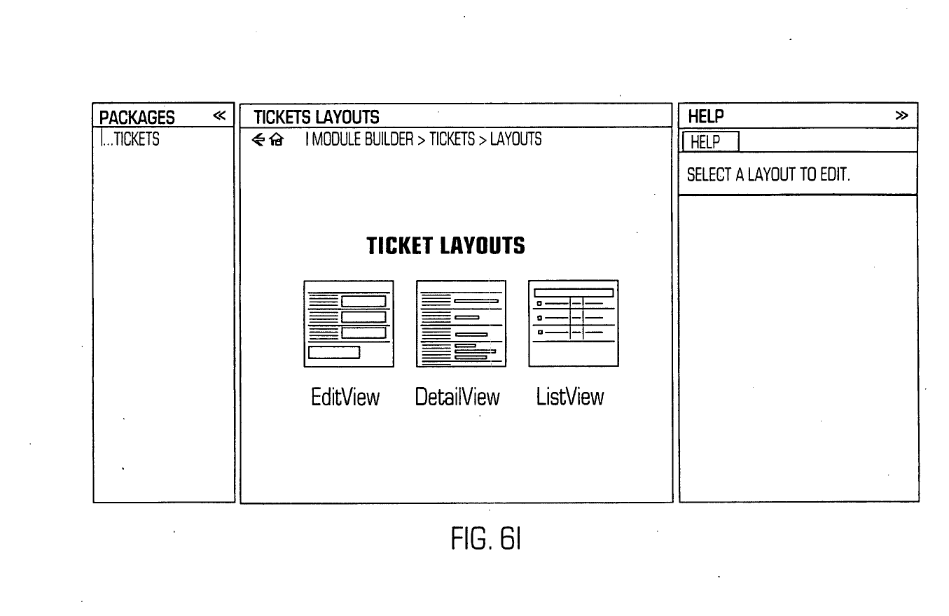

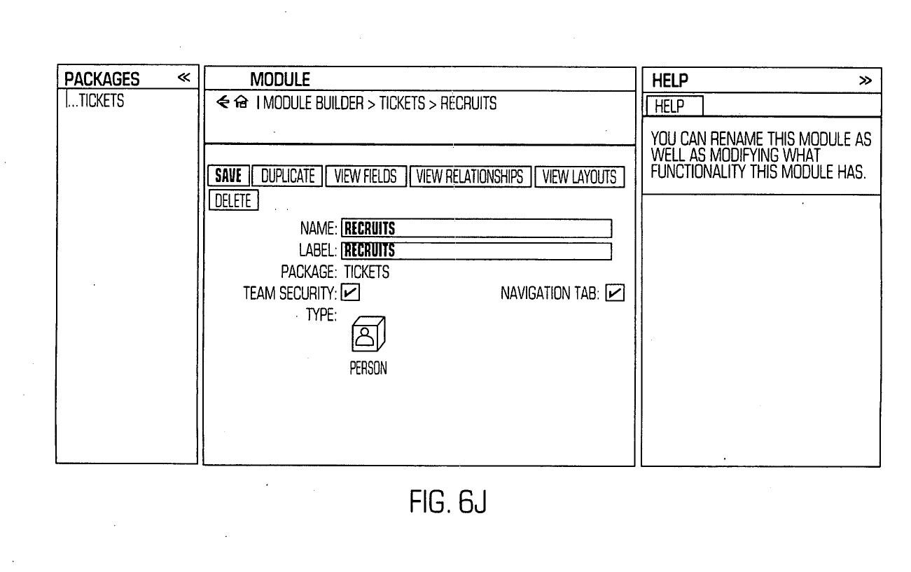

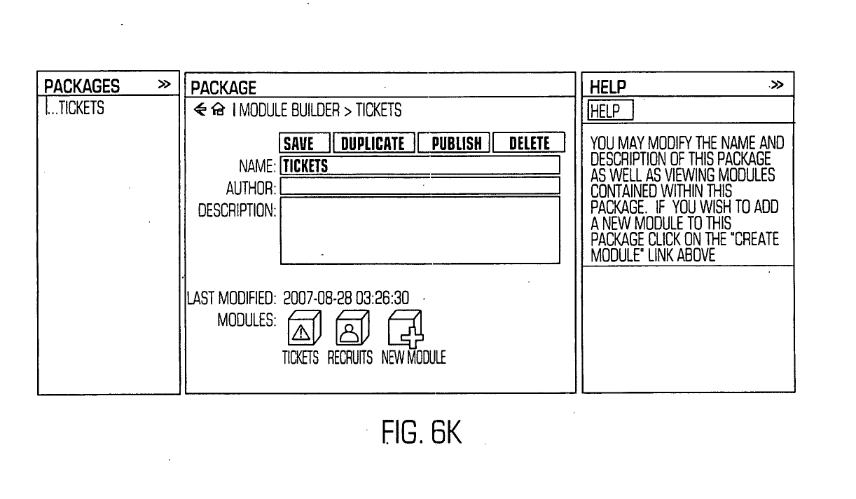

The module builder also may contain the ability to create packages of one or more business modules and these packages are an easier mechanism to transfer, deploy, and share multiple modules. FIG. 6A shows an embodiment of the module builder with a Tickets package. The screen may be composed of multiple sections that may show a tree of packages, a list of packages to edit, and a help screen. There may also be a portion of the screen dedicated to showing where in the structure the user currently is and allowing for quick navigation to other points in the structure.

The module builder system has multiple user interface sections that may also allow for those sections to be collapsed by hitting a button. These collapsed sections may be later shown by hitting another button or hovering over a region of the screen with the mouse. FIG. 6B shows the packets edit screen with the left panel collapsed.

FIG. 6C shows an edit screen for packages. The packages may contain a name, author, description, and zero or more modules. It is anticipated that the package structure will grow much richer as time goes by and hold more and more data and expand to include more component types.

Adding a new module to a package puts you on the module creation screen. This screen lets you fill in information about the module and pick which common types the module will support. FIG. 6D shows an embodiment of a user interface where, at the bottom of the user interface, basic, company, person, and issue are all available common types. In the example, the issue common type is selected. When a common type is picked, the metadata for the fields that are available and required may be shared from the definition of the type. This allows for quick creation of concepts that are similar to a component in the application. One example is creating a Tickets module as shown in FIG. 6E. This module is based on the issue common type and inherits all of its properties and behaviors.

Additional screens may be available to show the fields of an object as shown in FIG. 6F. The metadata for the fields may be viewable and/or editable in one of the screen regions. In FIG. 6F, the currently selected field is “tickets_number”. On the right, the field properties are available for editing. One such property may be if a field is audit-able.

There may also be a screen that shows the relationships in a module such as that shown in the embodiment shown in FIG. 6G. FIG. 6H shows the field after a new relationship was created using the edit view on the right hand side.

The ability to support multiple layouts and manage layouts may be a portion of the system. FIG. 6I shows the Layouts view for the Tickets module. Clicking on one of these three layouts may take you to a screen where you can view and edit that particular layout of the user interface for that module.

FIG. 6J shows the act of creating a Recruits module in the Tickets package wherein the module is based on the person object. FIG. 6K shows the Tickets package with both the Tickets and Recruits modules. Once a package is defined, many options may be available. These options may include but are not limited to:

1. save—Save any changes the user had made to the module

2. duplicate—Create a copy of the module

3. publish—Make the module available into this installation

4. delete—delete the package

5. export—export the package for backup, transfer, sharing, deployment on another installation, . . .

6. export and publish—export the package and publish it

An additional feature of package functionality may be an ability to provide prefixes to maintain uniqueness of the module namespaces. The concept of prefixing supports development and deployments of modules in a collaborative and parallel development environment and may further include the underlying data structures, folders, tables, schemas, directories, objects, and paths. Prefixing also enables multiple independent developers to create modules with similar names and for their customers to deploy those modules without worrying about naming conflicts. This prevents commonly used names from conflicting and making extensions incompatible with each other.

The prefixing feature is relevant both within a single application context and in a wider multiple application environment. In a distributed development environment this feature may be expanded to include a global unified registration service to accommodate for managing prefix assignment to different developers or development groups. With respect to the registration service, the service itself may either allow the developers to request a prefix or generate a unique prefix automatically. The service may have the ability to guarantee the uniqueness of the underlying prefixes to avoid all namespace collisions.

The ability to treat multiple modules as a package helps developers build solutions to meet business needs. Related modules can be treated as a single unit, transferred together, and also upgraded together. Keeping applications consistent is much easier if tightly couple portions are able to be handled as a unit.

### Shared Folders

The system may also include shared folders that allow users of the system to cooperate more effectively. A shared folder is a location where items can be linked. Shared folders may be able to contain one item type or multiple item types. An example of a shared folder that contains multiple item types is a task list that contains cases, calls, and tasks in a support environment. The shared folders may also support ordering of the items that allows the folder to function as a work queue.

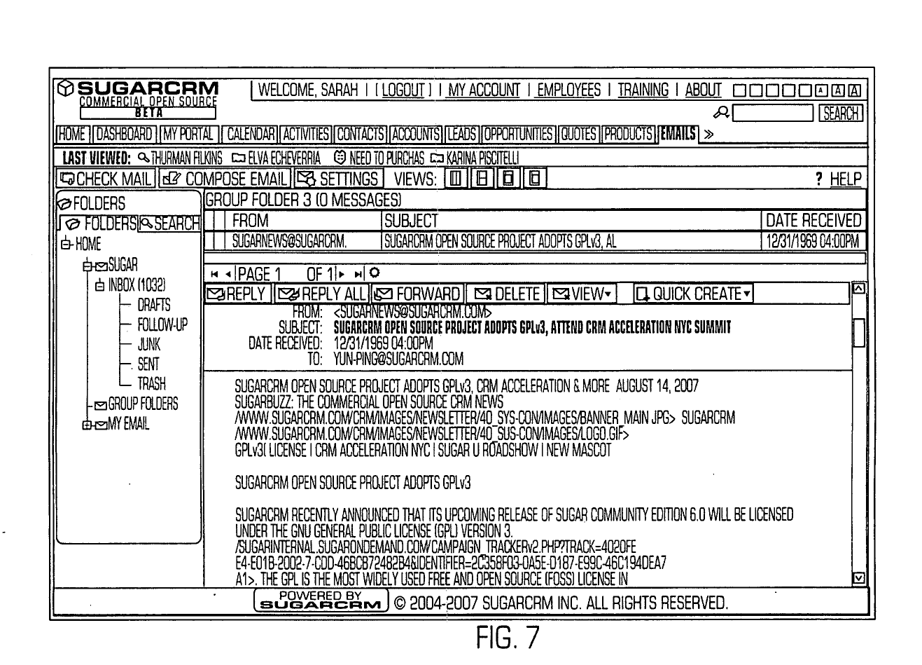

Shared folders may also support distribution of work among individuals. This distribution could be pull based where a user requests one or a multiple of items be assigned to him/her and then proceeds to work on those items. The distribution may also be push based where new items are assigned to the shared folder and are pushed out to users or other folders either immediately, or when some restriction is met. One example is a shared folder structure for a global support organization. Requests waiting for a response are sitting in the highest level shared folder. Each geographically distributed location has a shared folder for its work queue. During work hours, the shared folder for a location is kept open and the highest level folder is passing work items into the queue. When they shut down for the night, they close their queue and work items stop routing to them. This example shows the powerful nature of shared folders. FIG. 7 illustrates an example of a shared folder of the system.

A shared folder may also be used to track the state in a business process, trigger workflow, change visibility, and/or change ownership. The shared folders may also be used as collaborative workspaces wherein different users can log into a Shared Folder workspace and interactively work on documents.

While the foregoing has been with reference to a particular embodiment of the invention, it will be appreciated by those skilled in the art that changes in this embodiment may be made without departing from the principles and spirit of the invention, the scope of which is defined by the appended claims.

1. A software application system, comprising:
a computing device with a processing unit;
a database;
an application having a plurality of lines of computer code wherein the plurality of lines of computer code are executed by the processing unit of the computing device to generate a business application that accesses the database using one or more modules and one or more controllers; and
wherein the one or more modules further comprise a tracker module that tracks the performance of the application using one or more tables stored in the database that are updated with data based on each transaction with the database.

2. The system of claim 1, wherein the one or more tables further comprises a session table and wherein the tracker module tracks each session associated with the application and stores data about each session of the application in the session table.

3. The system of claim 1, wherein the one or more tables further comprises a queries table and wherein the tracker module tracks each query to the database and stores data about each query submitted to the database in the queries table.

4. The system of claim 1, wherein the one or more tables further comprises a performance table and wherein the tracker module tracks the performance of the application and stores data about the performance of the application in the performance table.

5. The system of claim 1, wherein the application further comprises a customer relationship management application.

6. The system of claim 1 further comprising a security module that restricts access to certain data in the database based on an access level of an authorized user.

7. The system of claim 6, wherein the tracker module further comprises a management tool based on the access level of the authorized user.

8. The system of claim 1, wherein the application further comprises shared folder that allow items in the database to be shared.

9. A computer implemented software application system that has a database and an application having a plurality of lines of computer code wherein the plurality of lines of computer code are executed by the computer, the method comprising:
generating a business application that accesses the database using one or more modules and one or more controllers; and
tracking the performance of the application using one or more tables stored in the database that are updated with data based on each transaction with the database.

10. The method of claim 9, wherein tracking the performance of the application further comprises tracking each session associated with the application and storing data about each session of the application in a session table.

11. The method of claim 9, wherein tracking the performance of the application further comprises tracking each query to the database and storing data about each query submitted to the database in a queries table.

12. The method of claim 9, wherein tracking the performance of the application further comprises storing data about the performance of the application in a performance table.

13. The method of claim 9 further comprising restricting access to certain data in the database based on an access level of an authorized user and generating a management tool based on the access level of the authorized user.

14. The method of claim 9 further comprising sharing data in the database using a shared folder.

15. A software application system, comprising:
a computing device with a processing unit;
a database;
an application having a plurality of lines of computer code wherein the plurality of lines of computer code are executed by the processing unit of the computing device to generate a business application that accesses the database using one or more modules and one or more controllers; and
wherein the one or more modules further comprise a reporting module having a plurality of graphs and charts having drill down functionality that illustrate the data pulled from the database using a query.

16. The system of claim 15, wherein the drill down functionality further comprises a legend section that provides more detail about a look, screen display or color assigned to the data in a particular graph or chart.

17. The system of claim 15, wherein the drill down functionality further comprises a drill down portion that drills down into the data shown in the graph or chart when a user hovers a cursor over the graph or chart.

18. The system of claim 15, wherein the application further comprises a customer relationship management application.

19. The system of claim 15, wherein the application further comprises shared folder that allow items in the database to be shared.

20. A computer implemented software application system that has a database and an application having a plurality of lines of computer code wherein the plurality of lines of computer code are executed by the computer, the method comprising:
generating a business application that accesses the database using one or more modules and one or more controllers; and
generating, using a reporting module, a plurality of graphs and charts that have drill down functionality that illustrate the data pulled from the database using a query.

21. The method of claim 20, wherein generating the plurality of graphs and charts further comprises generating a legend section that provides more detail about a look, screen display or color assigned to the data in a particular graph or chart.

22. The method of claim 20, wherein generating the plurality of graphs and charts further comprises drilling down into the data shown in the graph or chart when a user hovers a cursor over the graph or chart.

23. The method of claim 20 further comprising sharing data in the database using a shared folder.

24. A software application system, comprising:
a computing device with a processing unit;
a database;
an application having a plurality of lines of computer code wherein the plurality of lines of computer code are executed by the processing unit of the computing device to generate a business application that accesses the database using one or more modules and one or more controllers; and
wherein the one or more modules further comprise a security module that manages each field in the database that can be accessed by each user of the application and wherein the security module further comprises one or more access control lists wherein each access control list manages the a particular field in the database that can be accessed by each user of the application.

25. The system of claim 24, wherein each access control list further comprises one or more data field level access restrictions based on a role of a user of the application.

26. The system of claim 24, wherein each access control list further comprises a group field level access restrictions based on a role of a user of the application that groups one or more fields of the database.

27. The system of 24, wherein the data field level access restrictions further comprise one of “not set”, “read/write”, “read/owner write”, “read only”, “owner read/owner write” and “none”.

28. The system of claim 24, wherein the application further comprises a customer relationship management application.

29. The system of claim 24, wherein the application further comprises shared folder that allow items in the database to be shared.

30. A computer implemented software application system that has a database and an application having a plurality of lines of computer code wherein the plurality of lines of computer code are executed by the computer, the method comprising:
generating a business application that accesses the database using one or more modules and one or more controllers; and
managing each field in the database that can be accessed by each user of the application; and
wherein managing each field in the database further comprises generating one or more access control lists wherein each access control list manages the a particular field in the database that can be accessed by each user of the application.

31. The method of claim 30, wherein each access control list further comprises one or more data field level access restrictions based on a role of a user of the application.

32. The method of claim 30, wherein each access control list further comprises a group field level access restrictions based on a role of a user of the application that groups one or more fields of the database.

33. The method of 30, wherein the data field level access restrictions further comprise one of “not set”, “read/write”, “read/owner write”, “read only”, “owner read/owner write” and “none”.

34. The method of claim 30 further comprising sharing data in the database using a shared folder.

35. A software application system, comprising:
a computing device with a processing unit;
a database;
an application having a plurality of lines of computer code wherein the plurality of lines of computer code are executed by the processing unit of the computing device to generate a business application that accesses the database using one or more modules and one or more controllers; and
wherein the one or more modules further comprises a module builder that creates a new module based on one or more objects in the database.

36. The system of claim 35, wherein the module builder creates a new object based on the one or more objects in the database.

37. The system of claim 35, wherein the module builder creates a package of one or more modules.

38. The system of claim 37, wherein the module builder further comprises a prefixer to assign a unique name for each module created using the module builder.

39. The system of claim 35, wherein the application further comprises a customer relationship management application.

40. The system of claim 35, wherein the application further comprises shared folder that allow items in the database to be shared.

41. A computer implemented software application system that has a database and an application having a plurality of lines of computer code wherein the plurality of lines of computer code are executed by the computer, the method comprising:
generating a business application that accesses the database using one or more modules and one or more controllers; and
creating a new module based on one or more objects in the database.

42. The method of claim 41, wherein creating the new module further comprises creating a new object based on the one or more objects in the database.

43. The method of claim 41, wherein creating the new module further comprises creating a package of one or more modules.

44. The method of claim 43, wherein creating the new module further comprises assigning a unique name for each module created using a module builder.

45. The system of claim 41 further comprising sharing data in the database using a shared folder.
